(19) United States
(12) Patent Application Publication
(10) Pub. No.: US 2023/0061008 A1
(43) Pub. Date: Mar. 2, 2023

(54) LOW PROTEIN CHEESE HAVING IMPROVED STRETCH

(71) Applicant: CORN PRODUCTS DEVELOPMENT, INC, WESTCHESTER, IL (US)

(72) Inventors: Brandon ROA, Bridgewater, NJ (US); Adrianne SPERANZA, Bridgewater, NJ (US); Matthew YURGEC, Bridgewater, NJ (US); Vanessa ZAMARIN, Bridgewater, NJ (US)

(21) Appl. No.: 17/784,296

(22) PCT Filed: Dec. 10, 2020
(86) PCT No.: PCT/US2020/064228

§ 371 Date: Jun. 10, 2022

Related U.S. Application Data
(60) Provisional application No. 62/948,025, filed on Dec. 13, 2019.

(51) Int. Cl. A23C 20/00; A23L 29/25; A23L 29/212

(52) U.S. Cl. CPC A23C 20/00; A23L 29/25; A23L 29/212

(57) ABSTRACT

The technology disclosed in this specification pertains to imitations cheese comprising a grade 2 gum Arabic in an amount of from about 0.1% to about 1.0% and having a molecular weight of greater than about 800 kDa. In some embodiments the imitation cheese are low protein imitation cheeses having protein content of less than about 20%. It has been observed that the disclosed cheeses have an improved melt-stretch compared to imitation cheeses made with other hydrocolloids. It has further been observed low protein imitation cheeses comprising a grade 2 gum Arabic have a melt-stretch more like that of a full protein imitation cheese compared to the melt-stretch of imitation cheeses made with other hydrocolloids.

### CROSS-REFERENCE TO RELATED APPLICATIONS

This is a PCT International application which claims the benefit of U.S. Provisional Patent Application No. 62/948025, filed Dec. 13, 2019, which is incorporated by reference herein in its entirety.

The technology disclosed in this specification pertains to imitations cheese and more particularly to use of grade 2 gum Arabic in imitation cheese.

Imitation cheese is a cheese-like product that is commonly made from some mixture of casein, or its derivative, vegetable fats and oils, emulsifying salts, and flavorings. Makers of imitation cheese may replace some amount of the casein with other ingredients due to cost restrictions, but challenges exist in replacing the function lost by reducing casein.

The technology disclosed in this specification pertains to an imitation cheese comprising grade 2 gum Arabic, also called grade 2 gum Acacia, or grade 2 Acacia. Gum Arabic is a known gum product coming from various sources and is commonly available in two grades. Grade 1 is typically smaller in size, has lower phenolic content, and is a better emulsifier than grade 2 gum Arabic. In any embodiment, an imitation cheese, as described in this specification includes a grade 2 gum Arabic in an amount from about 0.1% to about 1.0%, or from about 0.2% to about 0.8%, or from about 0.2% to about 0.6%, or from about 0.3% to about 0.5% (w/w of the imitation cheese). In any embodiment, an imitation cheese, as described in this specification, comprises a grade 2 gum Arabic having a molecular weight of greater than about 800 kDa, or from about 800 kDa to about 1,500 kDa. In any embodiment, a reduced casein imitation cheese includes a grade 2 gum Arabic having a polyphenol content of from about 2000 gallic acid equivalents (GAE)/kg to about 2500 GAE/kg, or from about 2100 GAE/kg or about 2400 GAE/kg. In any embodiment, polyphenol content can be measured according to the method described in “Phenolic Content of Plum,” AJCS 6(4) 681-687 (2012), by Miletic et al. In any embodiment, an imitation cheese, as disclosed in this specification, comprises an unmodified gum Arabic, or unmodified grade 2 gum Arabic.

It has been observed that use of gum Arabic, as described in this specification, in reduced casein imitation cheeses improves the melt-stretch of an imitation cheese compared to imitations cheese made using other hydrocolloids. Within this specification melt-stretch is the height attainable by a pulled strand of melted imitation cheese before the strand breaks. Within this specification, melt-stretch can be measured using the following protocol: (1) Spread 45 g of store-bought pizza sauce on 8-inch store bought pre-baked pizza crust and top evenly with 80g shredded cheese. (2) Bake pizza at 400° F. (204° C.) for enough time to completely melt cheese, about 5 minutes. (3) Insert fork at about a 45-degree angle into the center of the pizza and slowly raise. Measure the highest point the strand reaches in inches before the strand breaks. This step is repeated at least two times. Without limitation, within in this specification, reference to improved melt or improved melt-stretch, includes increasing the maximum height of a strand of imitation cheese obtained according the melt-stretch test before the strand of imitation cheese breaks. Alternatively, the melt-stretch is measured as the maximum length achieved by the strand before breaking.

In any embodiment, a reduced casein imitation cheese comprising grade 2 gum Arabic, as described in this specification, has a maximum melt-stretch that is at least about 67% of the stretch of a full casein imitation cheese, or at least about 70%, or at least about 75%, or at least about 80%, or at least about 85%, or from about 67% to about 90%, or from about 70% to about 90%, or from about 75% to about 90%, or from about 80% to about 90%, or from about 82% to about 87%.

In any embodiment, a reduced casein imitation cheese comprising grade 2 gum Arabic, as described in this specification, has a melt-stretch that is at least 25% greater than a reduced casein imitation cheese comprising grade 1 gum Arabic, or at least about 33% greater, or at least about 40%, or at least about 45%, or at least about 50%, or from about 25% to about 60%, or from about 33% to about 60%, or from about 40% to about 60%, or from about 45% to about 60%, or from about 50% to about 60%, or from about 52% to about 57%.

Commonly, full casein imitation cheese has casein content of about 22.5% (w/w of the imitation cheeses). In any embodiment, a reduced casein imitation cheese comprising grade 2 gum Arabic, as described in this specification, has a casein content of less than about 20%, or less than about 15%, or from about 5% to about 15%, or from about 7% to about 15% or from about 10% to about 15%, or from about 11% to about 13% (w/w/of the imitation cheese). In any embodiment, a reduced casein imitation cheese comprising grade 2 gum Arabic, as described in this specification, has a protein content, of from about 5% to about 15% by weight of the imitation cheese or from about 8% to about 12% or from about 9% to about 11%. In any embodiment, a reduced casein imitation cheese comprising grade 2 gum Arabic, as described in this specification, has protein content provided solely by casein, which may be provided as non-fat milk solids. In any embodiment, a reduced casein imitation cheese comprising grade 2 gum Arabic, as described in this specification, has a protein content provided by casein of from about 5% to about 15% by weight of the imitation cheese or from about 8% to about 12% or from about 9% to about 11%, or 10% of the protein content in the imitation cheese. In any embodiment, a reduced casein imitation cheese comprising grade 2 gum Arabic, as described in this specification, has a protein content, obtained from a casein and a second protein, which may be protein from a plant source such as, but not limited to, a pulse, or pea, or chick pea, or lentil, or fava bean. Further, Applicants have observed that while grade 2 gum Arabic, used in reduced casein imitation cheese, as described in this specification, improves the melt-stretch of the imitation cheese. In contrast, grade 1 gum Arabic, used at similar amounts to those described in this specification in full casein imitation cheese tends to reduce the melt-stretch of the imitation cheese.

In any embodiment a reduced casein imitation cheese, as described in this specification, includes one or more of starch, emulsifying salts, flavorings, fat, and water. In any embodiment, a reduced casein imitation cheese, as described in this specification, includes an unsaturated fat, or a vegetable fat, or a vegetable fat that is solid or partially solid at room temperature (about 20° C.), or is a coconut oil, or a palm oil. In any embodiment a reduced casein imitation cheese, as described in this specification, includes a flavoring, for example an acidulent, or an organic acid, or lactic acid, or a salt (NaCl), or flavoring oil. In any embodiment a reduced casein imitation cheese, as described in this specification, grade 2 gum Arabic is the only gum or hydrocolloid (for example the imitation cheese does not include, among other things, modified celluloses, or carrageenan, xanthan gum, or tara gum, or konjac).

In any embodiment, a reduced casein imitation cheese, as described in this specification, includes a starch, or a modified starch. Modified starches useful in any embodiment of the disclosed reduced casein imitation cheese include singly and multiply modified starches. Suitable starch modifications include but are not limited to inhibition or chemical crosslinking (including using phosphate or adipate crosslinkers), stabilization or etherification or esterification using acetyl or hydroxypropyl groups, octenyl succinate groups, or derivatization or conversion to smaller size using heat, acid, oxidant, or enzyme. In any embodiment, a reduced casein imitation cheese, as described in this specification, includes oxidized starch, including for example oxidized starch shown to have good gelling capability. In any embodiment, a reduced casein imitation cheese, as described in this specification, includes a modified starch obtained from corn starch, tapioca starch, potato starch, pea starch, sago starch, rice starch, starch from another pulse source (including chickpea, lentil, and fava bean) and mixtures thereof. In any embodiment, a reduced casein imitation cheese, as described in this specification, includes a modified starch obtained from corn starch, tapioca starch, potato starch and mixtures thereof. In any embodiment, a reduced casein imitation cheese, as described in this specification, includes a modified starch obtained from potato starch. In any embodiment, a reduced casein imitation cheese, as described in this specification, includes a modified starch in an amount greater than about 5% or greater than about 7% or from about 5% to about 20% o from about 5% to about 15%, or from about 7% to about 15%, or from about 10% to about 15%, or from about 10% to about 14% (w/w of the imitation cheese).

In any embodiment, a reduced casein imitation cheese, as described in this specification, includes an emulsifying salt. In any embodiment, a reduced casein imitation cheese, as described in this specification, includes an emulsifying salt in an amount of from about 0.1 to about 2.0%, or from about 0.5% to about 1.5%, or from about 0.7% to about 1.5% or from about 1.0% to about 1.4%. In any embodiment, a reduced casein imitation cheese, as described in this specification, includes an emulsifying salt selected from the group consisting of citrate salts, phosphate salts, and mixture thereof, and optionally wherein the phosphate salts include at least one of a hexametaphosphate salt and dipotassium phosphate.

In any embodiment, a reduced casein imitation cheese, as described in this specification, includes a moisture content of from about 48% to about 52%, or from about 49% to about 51%, or from about 49% to about 50% (w/w of the imitation cheese).

Within this specification a reduced casein imitation cheese may have the formulation of Table 1 for comparative purposes, and wherein the hydrocolloid is any suitable hydrocolloid. Formulations of Table 1 using grade 2 gum Arabic are illustrative, non-limiting embodiments of the reduced casein imitation cheese including a grade 2 gum Arabic described in this specification.

TABLE 1
Test Reduced Casein Imitation Cheese

| | | % | % | % | | % |
|---|---|---|---|---|---|---|
| Ingredients | wt % | Protein | MSNF | Salt | % Fat | Solids |
| Rennet Casein | 12.50 | 10.00 | 11.31 | 0.00 | 0.14 | 11.50 |
| Water, DI | 46.00 | 0.00 | 0.00 | 0.00 | 0.00 | 0.00 |
| Palm Fat | 26.00 | 0.00 | 0.00 | 0.00 | 25.48 | 25.48 |
| Starch | 12.00 | 0.06 | 0.00 | 0.00 | 0.02 | 10.20 |
| Emulsifying | 1.20 | 0.00 | 0.00 | 0.60 | 0.00 | 1.14 |
| Salt | | | | | | |
| Salt | 1.50 | 0.00 | 0.00 | 0.75 | 0.00 | 1.35 |
| Lactic Acid | 0.40 | 0.00 | 0.00 | 0.00 | 0.00 | 0.36 |
| Hydrocolloid | 0.40 | 0.00 | 0.00 | 0.00 | 0.00 | 0.36 |
| Total | 100 | 10.06 | 11.31 | 1.35 | 25.64 | 50.39 |

The technology disclosed in this specification pertains to methods of making any embodiment of the reduced casein imitation cheese including grade 2 gum Arabic that are described in this specification. In any embodiment described in this specification, a method of making a low casein imitation cheese comprising a grade 2 gum Arabic includes mixing water, grade 2 gum Arabic, starch, casein, and a vegetable fat to obtain a mixture; heating the mixture with continued mixing to obtain a smooth cheese mass; and optionally adding a flavoring to the cheese mass and pulling the cheese mass to mix in the flavoring. In any embodiment described in this specification, a method of making a low casein imitation cheese comprising a grade 2 gum Arabic includes heating a mixture including casein, water, and grade 2 gum Arabic to between 70° and 80° C. for about 1 to about 10 minutes.

In any embodiment described in this specification, a method of making a low casein imitation cheese comprising a grade 2 gum Arabic includes pulling a cheese mass in a vacuum of less than 20 mmHg, or from about 5 to about 20 mmHg for from about 1 to about 10 minutes.

Within this specification, reference to “melt-stretch” means the height attainable by a strand of melted imitation cheese before the strand breaks using the melt-stretch test.

Within this specification, reference to a “melt-stretch test” means melt-stretch measured using the following protocol: (1) Spread 45 g of store-bought pizza sauce on 8-inch store bought pre-baked pizza crust and top evenly with 80 g shredded cheese. (2) Bake pizza at 400° F. (about 204° C.) for about 5 minutes (3) Insert fork at about a 45-degree angle into the center of the pizza and slowly raise, this step is repeated at least two times.

Within this specification, reference to a “test reduced casein imitation cheese” means the formulation of Table 1.

Within this specification, reference to a “full casein imitation cheese” means an imitation cheese having casein content 22.5% (w/w of the imitation cheese).

Use of “about” to modify a number in this specification is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” in this specification is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The technology is further described in the following aspects, which are intended to be illustrative, and are not intended to limit the full scope of the claims and their equivalents.

In a first aspect, the technology disclosed in this specification pertains to a reduced casein imitation cheese comprising an unmodified grade 2 gum Arabic in an amount of from about 0.1% to about 1.0%, or from about 0.2% to about 0.8%, or from about 0.2% to about 0.6%, or from about 0.3% to about 0.5% (w/w of the imitation cheese), the unmodified grade 2 gum Arabic having a molecular weight of greater than about 800 kDa or from about 800 kDa to about 1500 kDa.

In a second aspect, the technology disclosed in this specification pertains to the reduced casein imitation cheese of the first aspect further comprising casein in an amount of less than about 20%, or less than about 15%, or from about 5% to about 15%, or from about 7% to about 15%, or from about 10% to about 15%, or from about 11% to about 13% (w/w of the imitation cheese).

In a third aspect, the technology disclosed in this specification pertains to the reduced casein imitation cheese of the first or second aspects having a protein content from casein, of from about 5% to about 15% by weight of the imitation cheese or from about 8% to about 12%, or from about 9% to about 11%.

In fourth aspect, the technology disclosed in this specification pertains to the reduced imitation cheese of the any one of the first to third aspects having a protein content from casein and a second protein source, wherein the second protein source is a vegetable protein source, optionally wherein the second protein source is selected from the group consisting of a pulse, a pea, a chickpea, a lentil, a fava bean, and mixtures thereof.

In fifth aspect, the technology disclosed in this specification pertains to the reduced imitation cheese of any one of the first to fourth aspects wherein the unmodified grade 2 gum Arabic has a polyphenol content of from about 2000 GAE (gallic acid equivalents)/kg to about 2500 GAE/kg, or from about 2100 GAE/kg to about 2400 GAE/kg.

In sixth aspect, the technology disclosed in this specification pertains to the reduced imitation cheese of any one of the first to fifth aspects further comprising a modified starch selected from the group consisting of corn starch, pea starch, tapioca starch, potato starch, sago starch, rice starch, chickpea starch, lentil starch, fava bean starch, and mixtures thereof, wherein preferably the starch is selected from the group consisting of corn starch, tapioca starch, potato starch and mixtures thereof, and more preferably wherein the starch is a potato starch.

In seventh aspect, the technology disclosed in this specification pertains to the reduced imitation cheese of any one of the first to sixth aspects further comprising an oxidized starch.

In an eighth aspect, the technology disclosed in this specification pertains to the reduced imitation cheese of any one of the first to seventh aspects further comprising a modified starch in an amount greater than about 5%, or greater than about 7%, or from about 5% to about 20%, or from about 5% to about 15%, or from about 7% to about 15%, or from about 10% to about 15%, or from about 10% to about 14% (w/w of the imitation cheese).

In ninth aspect, the technology disclosed in this specification pertains to the reduced imitation cheese of any one of the first to eighth aspects further comprising an emulsifying salt in an amount of from about 0.1 to about 2.0%, or from about 0.5% to about 1.5%, or from about 0.7% to about 1.5% or from about 1.0% to about 1.4%.

In a tenth aspect, the technology disclosed in this specification pertains to the reduced imitation cheese of any one of the first to ninth aspects further comprising an emulsifying salt selected from the group consisting of citrate salts, phosphate salts, and mixture thereof, and optionally wherein the phosphate salts include at least one of a hexametaphosphate salt and dipotassium phosphate.

In an eleventh aspect, the technology disclosed in this specification pertains to the reduced casein imitation cheese of any one of the first to tenth aspects further comprising a moisture content of from about 48% to about 52%, or from about 49% to about 51%, or from about 49% to about 50% (w/w of the imitation cheese).

In a twelfth aspect, the technology disclosed in this specification pertains to the reduced casein imitation cheese of any one of the first to eleventh aspects wherein the reduced casein imitation cheese has a melt-stretch, as measured by a melt-stretch test, that is at least about 67% of a melt-stretch (as measured by the melt-stretch test) of a full casein imitation cheese, or at least about 70%, or at least about 75%, or at least about 80%, or at least about 85%, or from about 67% to about 90%, or from about 70% to about 90%, or from about 75% to about 90%, or from about 80% to about 90%, or from about 82% to about 87%.

In a thirteenth aspect, the technology disclosed in this specification pertains to the reduced casein imitation cheese of any one of the first to twelfth aspects wherein the reduced casein imitation cheese has a melt-stretch as measured by a melt-stretch test of at least 25% greater than a melt-stretch (as measured by the melt-stretch test) of a reduced casein imitation cheese comprising a grade 1 gum Arabic, or at least about 33%, or at least about 40%, or at least about 45%, or at least about 50%, or from about 25% to about 60%, or from about 33% to about 60%, or from about 40% to about 60%, or from about 45% to about 60%, or from about 50% to about 60%, or from about 52% to about 57%.

In a fourteenth aspect, the technology disclosed in this specification pertains to use of grade 2 gum Arabic to increase the melt-stretch of a reduced casein imitation cheese, wherein the reduced casein imitation cheese is as described in any one of the first to thirteenth aspects.

In a fifteenth aspect, the technology disclosed in this specification pertains to a method for making a reduced casein imitation cheese comprising: a) mixing water, grade 2 gum Arabic, starch, casein, and a vegetable fat to obtain a mixture; b) heating while continuing to mix the mixture to obtain a smooth cheese mass; and c) optionally adding a flavoring to the cheese mass and pulling the cheese mass to mix in the flavoring.

In a sixteenth aspect, the technology disclosed in this specification pertains to the method of the fifteenth aspect wherein the mixture is heated to between 70° and 80° C. for about 1 to about 10 minutes.

In a seventeenth aspect, the technology disclosed in this specification pertains to the method of the fifteenth and sixteenth aspects wherein the cheese mass is pulled in vacuum of less than 20 mmHg, or from about 5 to about 20 mmHg, or from about 1 to about 10 minutes.

In an eighteenth aspect, the technology disclosed in this specification pertains to the method of any one of the fifteenth to seventeenth aspects wherein the grade 2 gum Arabic is used in an amount of from about 0.1% to about 1.0%, or from about 0.2% to about 0.8%, or from about 0.2% to about 0.6%, or from about 0.3% to about 0.5% (w/w of the imitation cheese), and has molecular weight of greater than about 800 kDa, or from about 800 kDa to about 1500 kDa; and optionally wherein the unmodified grade 2 gum Arabic has a polyphenol content of from about 2000 GAE/kg to about 2500 GAE/kg, or from about 2100 GAE/kg to about 2400 GAE/kg.

In a nineteenth aspect, the technology disclosed in this specification pertains to the method of any one of the fifteenth to eighteen aspects wherein the casein is used in an amount of less than about 20%, or less than about 15% or from about 5% to about 15%, or from about 7% to about 15% or from about 10% to about 15%, or from about 11% to about 13% (w/w/of the imitation cheese).

In a twentieth aspect, the technology disclosed in this specification pertains to the method of any one the fifteenth to nineteenth aspects wherein the starch is a modified starch selected from the group consisting of corn starch, tapioca starch, or potato starch; and optionally wherein starch is modified by oxidation.

In a twenty-first aspect, the technology disclosed in this specification pertains to the method of any one of the fifteenth to twentieth aspects wherein the starch is a oxidized starch used in an amount greater than about 5%, or greater than about 7%, or from about 5% to about 20%, or from about 5% to about 15%, or from about 7% to about 15%, or from about 10% to about 15%, or from about 10% to about 14% (w/w of the imitation cheese).

In a twenty-second aspect, the technology disclosed in this specification pertains to the method of any one of the fifteenth to twenty-first aspects wherein the mixture formed in step a) further comprises an emulsifying salt in an amount of from about 0.1 to about 2.0%, or from about 0.5% to about 1.5%, or from about 0.7% to about 1.5%, or from about 1.0% to about 1.4%.

In a twenty-third aspect, the technology disclosed in this specification pertains to the method of any one of the fifteenth to twenty-second aspects wherein the mixture formed in step a) for making the reduced casein imitation cheese of any one of claims 1 to 7 further comprises an emulsifying salt selected from the group consisting of citrate salts, phosphate salts, and mixture thereof, and optionally wherein the phosphate salts include at least one of a hexametaphosphate salt and dipotassium phosphate.

In a twenty-fourth aspect, the technology disclosed in this specification pertains to the method of any one of the fifteenth to twenty-third aspects wherein the flavoring is lactic acid.

The technology is further described by the following examples, which are intended to be illustrative and are not intended to limit the full scope of the claims or their equivalents.

### EXAMPLE 1

### Cheese Formulation and Processes

### EXAMPLE 1

### Processes

All cheese samples were made in a pilot-scale blentech CC-0100 twin screw cheese cooker by indirect steam heating.

Process 1 for making full protein cheese (sample 1) and an imitation cheese using no gum Arabic or thermal hydrocolloids (sample 2) are as follows. 1. Water was added and heated in a cheese cooker to 100°-110° F. (about 37° C. to about 43° C.), followed by adding emulsifying salts, salt, and casein and mixing at 3 minute. 2. Starch followed by melted vegetable fat (e.g. palm fat) were incorporated and mixed. 3. The mixture was heated to 170° F. (about 76° C.) using indirect steam, and then held for 2-5 minutes until smooth, dough-like cheese mass is formed and starch is cooked. 4. Lactic acid was added, and the mixture was pulled in 10 mmHg vacuum while mixing for 1 minute. 5. Cheese mass was then dispensed into lined (plastic-wrap) 76 oz. plastic storage bags and stored at 40° F. (about 4° C.) for further analysis.

Process 2 was used to make imitation cheese comprised of other components such as xanthan, konjac, carrageenan, and tara gum (collectively thermal hydrocolloids) (Samples 4, 5, and 6). 1. Hydrocolloids were dispersed with salt in half of the water of the formulation in in the cheese cooker and were mixed without heat. 2. Cheese cooker heated to 200° F. (about 93° C.). After reaching this temperature, the heat was shut off and the remaining water was added to mixture as ice to cool mixture to about 110° F. (about)43°. During cooling the mass was mixed. 3. Emulsifying salts and casein, were then added and mixed for 3 minutes allowing the casein to fully hydrate at 110° F. (about)43°. Subsequent steps were the same as Process 1 steps 2 through 5.

### EXAMPLE 1B

### Formulas

Formulas for Samples 1 to 7 are reported in Tables 2 to 8. The imitation cheese of each sample was intended to imitate pizza cheese.

Sample 1 is a full casein cheese that does not include thermal hydrocolloids, gum Arabic, or starch. The formula for Sample 1 is reported in Table 2. Sample 1 has a moisture content of 50.69% (wt % of the cheese).

TABLE 2
Full Protein Imitation Cheese (Sample 1)

| | | % | % | % | | % |
|---|---|---|---|---|---|---|
| Ingredients | wt % | Protein | MSNF | Salt | % Fat | Solids |
| Rennet Casein | 22.50 | 18.00 | 20.36 | 0.00 | 0.25 | 20.70 |
| (Fonterra 90#) | | | | | | |
| Water, DI | 48.10 | 0.00 | 0.00 | 0.00 | 0.00 | 0.00 |
| Palm Fat | 26.00 | 0.00 | 0.00 | 0.00 | 25.48 | 25.48 |
| Modified Starch | 0.00 | 0.00 | 0.00 | 0.00 | 0.00 | 0.00 |
| Emulsifying | 1.50 | 0.00 | 0.00 | 0.75 | 0.00 | 1.43 |
| Salt* | | | | | | |
| Table Salt | 1.50 | 0.00 | 0.00 | 0.75 | 0.00 | 1.35 |
| Lactic Acid | 0.40 | 0.00 | 0.00 | 0.00 | 0.00 | 0.36 |
| Total | 100 | 18.00 | 20.36 | 1.50 | 25.73 | 49.32 |

Sample 2 is an imitation cheese made using no thermal hydrocolloid or gum Arabic (grade 1 or grade 2). Sample 2 includes 12% starch, has a casein reduction (compared to full casein imitation cheese) of about 44%, and has a moisture content of 49.97% (wt % of the Sample) and the formula for Sample 2 is reported in Table 3.

TABLE 3
Reduced Protein Imitation Cheese Using No
Thermal Hydrocolloid or Arabic (Sample 2)

| | | % | % | % | | % |
|---|---|---|---|---|---|---|
| Ingredients | wt % | Protein | MSNF | Salt | % Fat | Solids |
| Rennet Casein | 12.50 | 10.00 | 11.31 | 0.00 | 0.14 | 11.50 |
| Water, DI | 46.4 | 0.00 | 0.00 | 0.00 | 0.00 | 0.00 |
| Palm Fat | 26.00 | 0.00 | 0.00 | 0.00 | 25.48 | 25.48 |
| Modified Starch | 12.00 | 0.06 | 0.00 | 0.00 | 0.02 | 10.20 |
| Emulsifying | 1.20 | 0.00 | 0.00 | 0.60 | 0.00 | 1.14 |
| Salt | | | | | | |
| Table Salt | 1.50 | 0.00 | 0.00 | 0.75 | 0.00 | 1.35 |
| Lactic Acid | 0.40 | 0.00 | 0.00 | 0.00 | 0.00 | 0.36 |
| Total | 100 | 10.06 | 11.31 | 1.35 | 25.64 | 50.03 |

Sample 3 is an imitation cheese made using grade 2 gum Arabic. Sample 3 includes 12% starch, has a casein reduction (compared to full casein imitation cheese) of about 44%, and has a 49.61% moisture and the formula for Sample 3 is reported in Table 4.

TABLE 4
Imitation Cheese Using Grade 2 gum Arabic (Sample 3)

| | | % | % | % | | % |
|---|---|---|---|---|---|---|
| Ingredients | wt % | Protein | MSNF | Salt | % Fat | Solids |
| Rennet Casein | 12.50 | 10.00 | 11.31 | 0.00 | 0.14 | 11.50 |
| Water, DI | 46.0 | 0.00 | 0.00 | 0.00 | 0.00 | 0.00 |
| Palm Fat | 26.00 | 0.00 | 0.00 | 0.00 | 25.48 | 25.48 |
| Starch | 12.00 | 0.06 | 0.00 | 0.00 | 0.02 | 10.20 |
| Emulsifying | 1.20 | 0.00 | 0.00 | 0.60 | 0.00 | 1.14 |
| Salt | | | | | | |
| Salt | 1.50 | 0.00 | 0.00 | 0.75 | 0.00 | 1.35 |
| Lactic Acid | 0.40 | 0.00 | 0.00 | 0.00 | 0.00 | 0.36 |
| Gum Arabic | 0.40 | 0.00 | 0.00 | 0.00 | 0.00 | 0.36 |
| grade 2 | | | | | | |
| Total | 100 | 10.06 | 11.31 | 1.35 | 25.64 | 50.39 |

Sample 4 is an imitation cheese made using a xanthan gum, konjac mixture in a 2:3 ratio. Sample 4 includes 12% starch, has a casein reduction (compared to full casein imitation cheese) of about 44%, and has a 49.61% moisture and the formula for Sample 4 is reported in Table 5.

TABLE 5
Imitation Cheese Using Xanthan Gum and Konjac (Sample 4)

| | | % | % | % | | % |
|---|---|---|---|---|---|---|
| Ingredients | wt % | Protein | MSNF | Salt | % Fat | Solids |
| Rennet Casein | 12.50 | 10.00 | 11.31 | 0.00 | 0.14 | 11.50 |
| Water, DI | 46.0 | 0.00 | 0.00 | 0.00 | 0.00 | 0.00 |
| Palm Fat | 26.00 | 0.00 | 0.00 | 0.00 | 25.48 | 25.48 |
| Starch | 12.00 | 0.06 | 0.00 | 0.00 | 0.02 | 10.20 |
| Emulsifying | 1.20 | 0.00 | 0.00 | 0.60 | 0.00 | 1.14 |
| Salt | | | | | | |
| Salt | 1.50 | 0.00 | 0.00 | 0.75 | 0.00 | 1.35 |
| Lactic Acid | 0.40 | 0.00 | 0.00 | 0.00 | 0.00 | 0.36 |
| Xanthan Gum | 0.16 | 0.00 | 0.00 | 0.00 | 0.00 | 0.14 |
| Powder | | | | | | |
| Konjac | 0.24 | 0.00 | 0.00 | 0.00 | 0.00 | 0.22 |
| Total | 100 | 10.06 | 11.31 | 1.35 | 25.64 | 50.39 |

Sample 5 is an imitation cheese made using xanthan gum and tara gum in a 1:1 ratio. Sample 5 includes 12% starch, has a casein reduction (compared to full casein imitation cheese) of about 44%, and has a 49.61% moisture and the formula for Sample 5 is reported in Table 6.

TABLE 6
Imitation Cheese Using Xanthan Gum and Tara Gum (Sample 5)

| | | % | % | % | | % |
|---|---|---|---|---|---|---|
| Ingredients | wt % | Protein | MSNF | Salt | % Fat | Solids |
| Rennet Casein | 12.50 | 10.00 | 11.31 | 0.00 | 0.14 | 11.50 |
| Water, DI | 46.0 | 0.00 | 0.00 | 0.00 | 0.00 | 0.00 |
| Palm Fat | 26.00 | 0.00 | 0.00 | 0.00 | 25.48 | 25.48 |
| Starch | 12.00 | 0.06 | 0.00 | 0.00 | 0.02 | 10.20 |
| Emulsifying | 1.20 | 0.00 | 0.00 | 0.60 | 0.00 | 1.14 |
| Salt | | | | | | |
| Salt | 1.50 | 0.00 | 0.00 | 0.75 | 0.00 | 1.35 |
| Lactic Acid | 0.40 | 0.00 | 0.00 | 0.00 | 0.00 | 0.36 |
| Xanthan Gum | 0.20 | 0.00 | 0.00 | 0.00 | 0.00 | 0.18 |
| Tara Gum | 0.20 | 0.00 | 0.00 | 0.00 | 0.00 | 0.18 |
| Total | 100 | 10.06 | 11.31 | 1.35 | 25.64 | 50.39 |

Sample 6 is an imitation cheese made using carrageenan and tara gum in a 1.5:5 ratio. Sample 5 includes 12% starch, has a casein reduction (compared to full casein imitation cheese) of about 44%, and has a 49.61% moisture and the formula for Sample 6 is reported in Table 7.

TABLE 7
Imitation Cheese Using Carrageenan and Tara Gum (Sample 6)

| | | % | % | % | % | % |
|---|---|---|---|---|---|---|
| Ingredients | % | Protein | MSNF | Salt | Fat | Solids |
| Rennet Casein | 12.50 | 10.00 | 11.31 | 0.00 | 0.14 | 11.50 |
| Water, DI | 46.0 | 0.00 | 0.00 | 0.00 | 0.00 | 0.00 |
| Palm Fat | 26.00 | 0.00 | 0.00 | 0.00 | 25.48 | 25.48 |
| Starch | 12.00 | 0.06 | 0.00 | 0.00 | 0.02 | 10.20 |
| Emulsifying | 1.20 | 0.00 | 0.00 | 0.60 | 0.00 | 1.14 |
| Salt | | | | | | |
| Salt | 1.50 | 0.00 | 0.00 | 0.75 | 0.00 | 1.35 |
| Lactic Acid | 0.40 | 0.00 | 0.00 | 0.00 | 0.00 | 0.36 |
| Carrageenan | 0.31 | 0.00 | 0.00 | 0.00 | 0.00 | 0.28 |
| Tara Gum | 0.09 | 0.00 | 0.00 | 0.00 | 0.00 | 0.08 |
| Total | 100 | 10.06 | 11.31 | 1.35 | 25.64 | 50.39 |

Sample 7 is an imitation cheese made using grade 2 gum Arabic. Sample 3 includes 12% starch, has a casein reduction (compared to full casein imitation cheese) of about 44%, and has a 49.61% moisture and the formula for Sample 7 is reported in Table 8.

TABLE 8
Imitation Cheese Using Grade 1 gum Arabic (Sample 7)

| | | % | % | % | | % |
|---|---|---|---|---|---|---|
| Ingredients | wt % | Protein | MSNF | Salt | % Fat | Solids |
| Rennet Casein | 12.50 | 10.00 | 11.31 | 0.00 | 0.14 | 11.50 |
| Water, DI | 46.0 | 0.00 | 0.00 | 0.00 | 0.00 | 0.00 |
| Palm Fat | 26.00 | 0.00 | 0.00 | 0.00 | 25.48 | 25.48 |
| Starch | 12.00 | 0.06 | 0.00 | 0.00 | 0.02 | 10.20 |
| Emulsifying Salt | 1.20 | 0.00 | 0.00 | 0.60 | 0.00 | 1.14 |
| Salt | 1.50 | 0.00 | 0.00 | 0.75 | 0.00 | 1.35 |
| Lactic Acid | 0.40 | 0.00 | 0.00 | 0.00 | 0.00 | 0.36 |
| Gum Arabic | 0.40 | 0.00 | 0.00 | 0.00 | 0.00 | 0.36 |
| grade 1 | | | | | | |
| Total | 100 | 10.06 | 11.31 | 1.35 | 25.64 | 50.39 |

### EXAMPLE 1C

### Methods

Applicants evaluated the ability of the various gum and hydrocolloids systems to provide stretch to melted imitation (reduced casein) cheese. Maximum melt-stretch height was measured using the following protocol: 1. Spread 45 g of store-bought pizza sauce on 8-inch store bought pre-baked pizza crust and top evenly with 80 g shredded cheese made according to the formulations described above. 2. Bake pizza at 400° F. (about 204° C.) with fan on and browning setting off 3. Insert fork at a 45-degree angle into the center of the pizza and slowly raise, this step is repeated at least two times. Maximum melt-stretch is the maximum height of a cheese strand achieves before breaking.

### EXAMPLE 1D

### Results

Maximum melt-stretch of samples 1 to 7 is reported in Table 9.

TABLE 9
Maximum Stretch Height of Samples
Maximum Stretch Height

| Sample | Formula Variant | Stretch Ht (in.) | |
|---|---|---|---|
| 1 | Full Casein | 13 | (about 33 cm) |
| 2 | Imitation 0% Gum/Hydrocolloid | 7 | (about 18 cm) |
| 3 | Gum Arabic Grade 2 (0.4%) | 11 | (about 28 cm) |
| 4 | Xanthan Gum/Konjac (2:3, 0.4%) | 5.5 | (about 14 cm) |
| 5 | Xanthan/Tara Gum (1:1, 0.4%) | 4 | (about 10 cm) |
| 6 | Carrageenan/Tara Gum (1.5:5, 0.4%) | 7 7 | (about 18 cm) |
| 7 | Gum Arabic Grade 1 (0.4%) | 5 | (about 13 cm) |

1. A reduced casein imitation cheese comprising an unmodified grade 2 gum Arabic in an amount of from about 0.1% to about 1.0%, (w/w of the imitation cheese), the unmodified grade 2 gum Arabic having a molecular weight of greater than about 800 kDa.

2. The reduced casein imitation cheese of claim 1 further comprising casein in an amount of less than about 20%, (w/w of the imitation cheese).

3. The reduced casein imitation cheese of claim 1 having a protein from casein, of from about 5% to about 15%, by weight of the imitation cheese.

4. The reduced casein imitation cheese of claim 1 having a protein content from casein and a second protein source, wherein the second protein source is a vegetable protein source.

5. The reduced casein imitation cheese of claim 1 wherein the unmodified grade 2 gum Arabic has a polyphenol content of from about 2000 GAE (gallic acid equivalents)/kg to about 2500 GAE/kg.

6. The reduced casein imitation cheese of claim 1 further comprising a modified starch selected from the group consisting of corn starch, pea starch, tapioca starch, potato starch, sago starch, rice starch, chickpea starch, lentil starch, fava bean starch, and mixtures.

7. The reduced casein imitation cheese of claim 1 further comprising an oxidized starch.

8. The reduced casein imitation cheese of claim 1 further comprising a modified starch in an amount greater than about 5%.

9. The reduced casein imitation cheese of claim 1 further comprising an emulsifying salt in an amount of from about 0.1 to about 2.0%.

10. The reduced casein imitation cheese claim 1 further comprising an emulsifying salt selected from the group consisting of citrate salts, phosphate salts, and mixture thereof.

11. The reduced casein imitation cheese of claim 1 further comprising a moisture content of from about 48% to about 52%, (w/w of the imitation cheese).

12. (canceled)

13. (canceled)

14. (canceled)

15. A method for making a reduced casein imitation cheese comprising:
a) mixing water, grade 2 gum Arabic, starch, casein, and a vegetable fat to obtain a mixture;
b) heating while continuing to mix the mixture to obtain a smooth cheese mass.

16. The method of claim 15 wherein the mixture is heated to between 70° and 80° C. for about 1 to about 10 minutes.

17. The method of claim 15 further comprising pulling the cheese mass in a vacuum of less than 20 mmHg, for about 1 to about 10 minutes.

18. The method of claim 15 wherein the grade 2 gum Arabic is used in an amount of from about 0.1% to about 1.0 (w/w of the imitation cheese), and has molecular weight of greater than about 800 kDa.

19. The method of claim 15 wherein the casein is in an amount of less than about 20%.

20. The method of claim 15 wherein the starch is a modified starch, the starch selected from the group consisting of corn starch, tapioca starch, or potato starch and mixtures thereof. by oxidation.

21. The method of claim 15 wherein the starch is a oxidized starch used in an amount greater than about 5%, (w/w of the imitation cheese).

22. The method claim 15 wherein the mixture formed in step a) further comprises an emulsifying salt in an amount of from about 0.1 to about 2.0%.

23. (canceled)

24. The method of claim 15 wherein the flavoring is lactic acid.
